(19) United States
(12) Patent Application Publication
(10) Pub. No.: US 2026/0233637 A1
(43) Pub. Date: Aug. 13, 2026

(54) SEAT SENSOR SYSTEM FOR A VEHICLE

(71) Applicant: GM Global Technology Operations LLC, Detroit, MI (US)

(72) Inventors: Oren Longman, Tel Aviv (IL); Tzvi Philipp, Bet Shemesh (IL)

(73) Assignee: GM Global Technology Operations LLC, Detroit, MI (US)

(21) Appl. No.: 19/049,137

(22) Filed: Feb. 10, 2025

(51) Int. Cl. B60N 2/00; B60R 22/48

(52) U.S. Cl. CPC B60N 2/0026; B60N 2/0034; B60N 2210/48; B60N 2220/30; B60N 2230/10; B60R 22/48

(57) ABSTRACT

A computer-implemented method when executed by data processing hardware causes the data processing hardware to perform operations. The operations include receiving, from a plurality of seat sensors, sensor data associated with a seat of a vehicle, determining the sensor data exceeds an activation threshold of a seat sensor application, and activating, based on the sensor data exceeding the activation threshold, the seat sensor application. The operations also include aggregating the sensor data via the seat sensor application, classifying, based on the aggregated sensor data, an object at the seat into an object class, and generating, based on the object class, a signal corresponding to the object via the seat sensor application.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a seat sensor system for a vehicle.

Vehicles are often equipped with sensors as part of seating assemblies. The sensors may be used to detect an occupant based on weight or other contact-based sensing technology. The sensors are typically used with a seat belt alarm to notify an occupant if a seat belt is not fastened. Traditional sensors are arranged in a daisy-chain configuration with each sensor arranged in parallel. As a result, the sensors do not provide spatial mapping of a respective sensor relative to a location on the seat. The parallel configuration may result in false activations for various objects that may be placed on the seat without use of the seat belt. Thus, there is a need for an improved sensor system that can provide spatial mapping along the seat to provide an improved mapping of an object on the seat.

### SUMMARY

In some aspects, a computer-implemented method when executed by data processing hardware causes the data processing hardware to perform operations. The operations include receiving, from a plurality of seat sensors, sensor data associated with a seat of a vehicle, determining the sensor data exceeds an activation threshold of a seat sensor application, and activating, based on the sensor data exceeding the activation threshold, the seat sensor application. The operations also include aggregating the sensor data via the seat sensor application, classifying, based on the aggregated sensor data, an object at the seat into an object class, and generating, based on the object class, a signal corresponding to the object via the seat sensor application.

In some examples, the sensor data may include pressure data, spatial data, and temporal data. Optionally, classifying the object may include analyzing the sensor data at a first time point and a second time point and comparing the sensor data at the first time point with the sensor data at the second time point. In some instances, comparing the sensor data at the first time point with the sensor data at the second time point may include identifying a location change of the object. In further examples, identifying the location change may include detecting, via a first seat sensor, the sensor data at the first time point and detecting, via a second seat sensor, the sensor data at the second time point.

Optionally, the plurality of seat sensors may be linear piezoelectric sensors, and each seat sensor may be configured to independently capture the sensor data. In some configurations, the plurality of seat sensors may be disposed in one or more of a seat base, a backrest, a headrest, and armrests of the seat and a floor space proximate to the seat. In some instances, classifying the object may include identifying the object class based on the sensor data, the object class including one of a child class, an adult class, a pet class, and an inanimate class. In some examples, generating the signal includes issuing a notification at a user interface of the vehicle.

In other aspects, a seat sensor system includes data processing hardware and memory hardware in communication with the data processing hardware. The memory hardware stores instructions that when executed on the data processing hardware cause the data processing hardware to perform operations. The operations include receiving, from a plurality of seat sensors, sensor data associated with a seat of a vehicle, the plurality of sensors disposed in at least one of a seat base, a backrest, and a headrest of the seat, determining the sensor data exceeds an activation threshold of a seat sensor application, and activating, based on the sensor data exceeding the activation threshold, the seat sensor application. The operations also include aggregating the sensor data via the seat sensor application, classifying, based on the aggregated sensor data, an object at the seat into an object class, the object class including one of an inanimate class and an animate class, and generating, based on the object class, a signal corresponding to the object via the seat sensor application.

In some examples, the sensor data may include pressure data, spatial data, and temporal data. Optionally, classifying the object may include analyzing the sensor data at a first time point and a second time point and comparing the sensor data at the first time point with the sensor data at the second time point. In some instances, comparing the sensor data at the first time point with the sensor data at the second time point may include identifying a location change of the object. In some configurations, identifying the location change may include detecting, via a first seat sensor, the sensor data at the first time point and detecting, via a second seat sensor, the sensor data at the second time point. Optionally, the plurality of seat sensors may be linear piezoelectric sensors, and each seat sensor may be configured to independently capture the sensor data. In some instances, generating the signal may include issuing a notification at a user interface of the vehicle.

In further aspects, a seat sensor system for a vehicle includes data processing hardware and memory hardware in communication with the data processing hardware. The memory hardware stores instructions that when executed on the data processing hardware cause the data processing hardware to perform operations. The operations include receiving, from a plurality of seat sensors, sensor data associated with a seat of the vehicle, the plurality of seat sensors disposed in at least one of a seat base, a backrest, and a headrest of the seat, each seat sensor being configured to independently capture the sensor data, determining the sensor data exceeds an activation threshold of a seat sensor application, activating, based on the sensor data exceeding the activation threshold, the seat sensor application, and aggregating the sensor data via the seat sensor application. The operations also include analyzing the sensor data at a first time point and a second time point, comparing the sensor data at the first time point with the sensor data at the second time point, classifying, based on the aggregated sensor data, an object at the seat into an object class, the object class including one of an inanimate class and an animate class, and generating, based on the object class, a signal corresponding to the object via the seat sensor application.

In some examples, the sensor data may include pressure data, spatial data, and temporal data. Optionally, comparing the sensor data at the first time point with the sensor data at the second time point may include identifying a location change of the object. In some instances, identifying the location change may include detecting, via a first seat sensor, the sensor data at the first time point and detecting, via a second seat sensor, the sensor data at the second time point.

### BRIEF DESCRIPTION OF THE DRAWINGS

The drawings described herein are for illustrative purposes only of selected configurations and are not intended to limit the scope of the present disclosure.

FIG. 1 is a perspective view of a vehicle equipped with a seat sensor system according to the present disclosure;

FIG. 2 is a partial perspective view of an interior of a vehicle with an adult occupant and a child occupant on seats equipped with a seat sensor system according to the present disclosure;

FIG. 3 is an exemplary block diagram of a seat sensor system according to the present disclosure;

FIG. 4 is a perspective view of a seat including a seat sensor system according to the present disclosure;

FIG. 5 is a perspective view of a seat sensor system according to the present disclosure;

FIG. 6 is an example flow diagram of operation of a seat sensor system according to the present disclosure; and

FIG. 7 is an exemplary method of operation of a seat sensor system according to the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

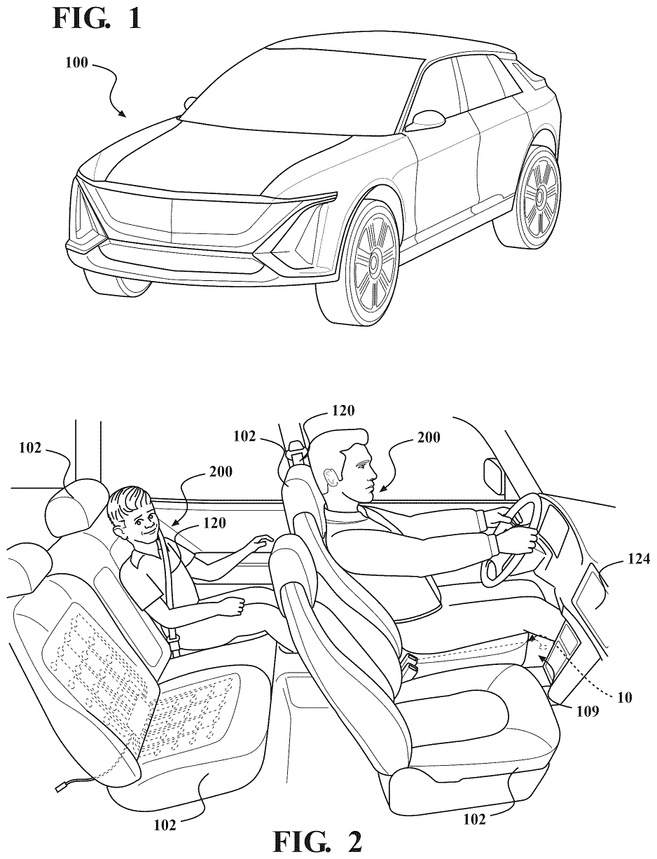

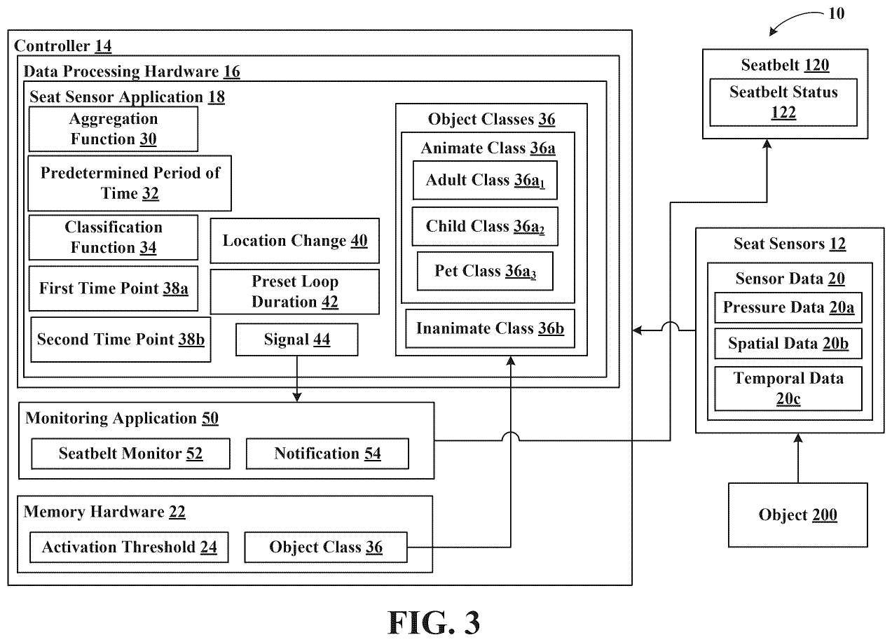

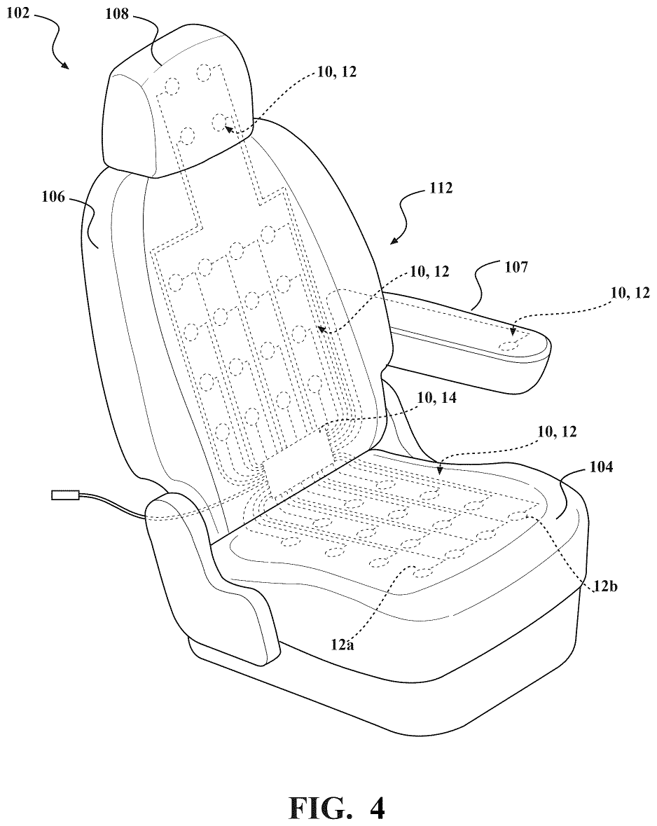

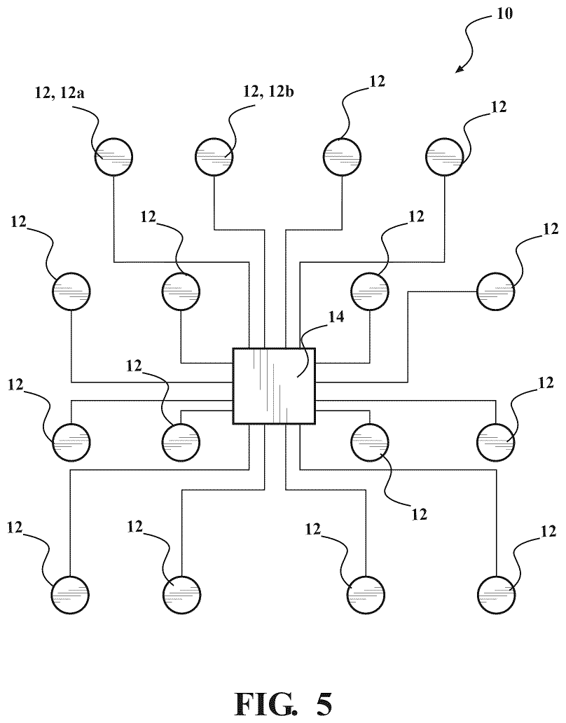

Referring to FIGS. 1-5, a seat sensor system 10 is configured for a vehicle 100 and is integrally formed in one or more seats 102 of the vehicle 100. The seats 102 of the vehicle 100 include a seat base 104, a backrest 106, armrests 107, and a headrest 108. The seat sensor system 10 includes a plurality of seat sensors 12 disposed in at least one of the seat base 104, the backrest 106, the armrests 107, and the headrest 108. The seat sensors 12 may also be disposed in a floor space 109 proximate to the seats 102. For example, the seat sensors 12 disposed within the floor space 109 may detect pressure applied from placement of an object 200, such as a bag or box, and/or pressure applied by feet of an occupant. As described in more detail below, the plurality of seat sensors 12 at each location of the seats 102 are configured to detect an object 200 on, near, or proximate to the seat 102. The varied locations of the seat sensors 12 along the seat 102 (i.e., in the headrest 108, the backrest 106, and/or the seat base 104) assist the seat sensor system 10 in classifying the object 200, described below.

The seat sensor system 10 includes a controller 14 including data processing hardware 16. The data processing hardware 16 is configured to execute a seat sensor application 18. The seat sensor application 18 receives sensor data 20 from each seat sensor 12 of the plurality of seat sensors 12. The seat sensor system 10 also includes memory hardware 22 that is in communication with the data processing hardware 16. The memory hardware 22 stores instructions that when executed on the data processing hardware 16 cause the data processing hardware 16 to perform operations. The memory hardware 22 also stores an activation threshold 24 associated with the seat sensor application 18. The seat sensor application 18 may remain generally inactive until the sensor data 20 exceeds the activation threshold 24 stored in the memory hardware 22.

For example, the sensor data 20 is received at the data processing hardware 16, and the data processing hardware 16 may determine whether the sensor data 20 exceeds the activation threshold 24 of the seat sensor application 18. If the sensor data 20 does not exceed the activation threshold 24, then the data processing hardware 16 continues to monitor the sensor data 20 and leaves the seat sensor application 18 in the inactive state. The seat sensor application 18 is activated by the data processing hardware 16 when the sensor data 20 exceeds the activation threshold 24. The sensor data 20 is captured by each individual seat sensor 12 and communicated with the data processing hardware 16 of the controller 14.

With further reference to FIGS. 1-5, the seat sensors 12 are configured to capture individual measurements (i.e., individual sensor data 20) as a result of a linear configuration of the seat sensors 12 in the seats 102. The seat sensors 12 may be linear piezoelectric sensors 12 that each independently capture the sensor data 20. Each seat sensor 12 is individually sampled for sensor data 20 and is correlated to a physical location on the seat 102. For example, an individual seat sensor 12 may be associated with one of the seat base 104, the backrest 106, and the headrest 108 and also associated with a specific location at the one of the seat base 104, the backrest 106, and the headrest 108. The seat sensors 12 each provide the sensor data 20 associated with a discrete location along the seat 102, such that the seat sensor application 18 may utilize the sensor data 20 to classify the detected object 200.

The sensor data 20 may include, but is not limited to, pressure data 20a, spatial data 20b, and/or temporal data 20c. Each aspect of the sensor data 20 may be utilized to assess and classify the object based on each aspect (i.e., pressure data 20a, spatial data 20b, and temporal data 20c) of the sensor data 20. For example, a first seat sensor 12a may be disposed on a first side 110 of the seat 102 in the seat base 104 and a second seat sensor 12b may be disposed on a second side 112 of the seat 102 in the backrest 106. The sensor data 20 captured by the first seat sensor 12a and the sensor data 20 captured by the second seat sensor 12b are communicated with the data processing hardware 16. If the sensor data 20 exceeds the activation threshold 24, then the seat sensor application 18 is activated. In response, the seat sensor application 18 may aggregate the sensor data 20 from the first seat sensor 12a with the sensor data 20 from the second seat sensor 12b.

For example, the seat sensor application 18 may execute an aggregation function 30 during which the seat sensor application 18 receives and records sensor data 20 for a predetermined period of time 32. Once aggregated, the seat sensor application 18 executes a classification function 34 on the aggregated sensor data 20. The classification function 34 is configured to classify the detected object 200 into an object class 36. The object class 36 includes an animate class 36a and an inanimate class 36b. The animate class 36a includes living objects, such as adult persons, child persons, and/or pets. For example, the animate class 36a may include an adult class 36a₁, a child class 36a₂, and a pet class 36a₃. The inanimate class 36b includes non-living objects, such as packages, bags, boxes, and/or any other non-living object. The object classes 36 may be stored in the memory hardware 22 and communicated with the seat sensor application 18 during execution of the classification function 34.

The seat sensor application 18 executes the classification function 34 based on the sensor data 20 to classify the object 200 at the seat 102 into one of the object classes 36. For example, the seat sensor application 18 may identify the object 200 as an animate object and initially classify the object 200 in the animate class 36a. The animate class 36 has multiple sub-classifications, such that the seat sensor application 18 may continue to aggregate and classify the sensor data 20 until one of the sub-classifications (i.e., adult class 36a₁, child class 36a₂, or pet class 36a₃) is identified. For example, the pressure data 20a of the sensor data 20 may indicate that the object 200 is an adult based on the pressure applied to seat 102, and the classification function 34 may classify the object 200 in the adult class 36a₁ of the animate class 36a. In other instances, the pressure data 20a may indicate that the object 200 is not an adult, and the classification function 34 may utilize the spatial data 20b and the temporal data 20c to differentiate between the child class 36a₂ and the pet class 36a₃.

The spatial data 20b may indicate the general distribution of the object 200 along the seat 102, and the temporal data 20c indicates the change in distribution of the object 200 over time. The classification function 34 may be programmed to identify that a pet (i.e., an animal, such as a cat or dog) may move or alter positions on the seat 102 more frequently than a child. However, the classification function 34 may utilize a greater aggregation of data points from the sensor data 20 to differentiate between the child class 36a₂ and the pet class 36a₃.

For example, the seat sensor application 18 may analyze the sensor data 20 at a first time point 38a and at a second time point 38b and compare the sensor data 20 at the first time point 38a with the sensor data 20 at the second time point 38b. The first time point 38a and the second time point 38b may span a predetermined time frame, such that a first set of sensor data 20 may be captured during the first time point 38a and a second set of sensor data 20 may be captured during the second time point 38b. The extended duration of time provides the seat sensor application 18 with a range of data points corresponding to the positioning of the object 200 on the seat 102. While the classification function 34 may utilize the comparison of the sensor data 20 at the respective time points 38a, 38b to classify the object 200 into one of the child class 36a₂ and the pet class 36a₃, the classification function 34 may utilize the comparison for other classification operations as well (i.e., classifying the object 200 into other animate classes 36a and/or into the inanimate class 36b).

Depending on the object 200, the object 200 may shift or otherwise move relative to the seat 102. The seat sensors 12 may detect changes in position of the object 200, as each seat sensor 12 individually and independently captures sensor data 20. The classification function 34 may result in identifying a location change 40 of the object 200 relative to the seat 102 based on the comparison of the sensor data 20 at the first time point 38a with the sensor data 20 at the second time point 38b. For example, the first seat sensor 12a may detect the sensor data 20 at the first time point 38a, and the second seat sensor 12b may detect the sensor data 20 at the second time point 38b.

The seat sensor application 18 is configured to loop the aggregation function 30 and the classification function 34 for a preset loop duration 42. The preset loop duration 42 is configured for the seat sensor application 18 to be able to validate the determined object class 36 with the continually gathered sensor data 20 from each of the seat sensors 12. By executing the aggregation function 30 and the classification function 34 for the preset loop duration 42, the seat sensor application 18 may minimize the potential of misclassification of the object 200 by aggregating and analyzing sensor data 20 gathered at multiple time points.

With further reference to FIGS. 1-5, the seat sensor application 18 is utilized by the seat sensor system 10 in combination with a monitoring application 50. The monitoring application 50 may be utilized to monitor various aspects of objects 200 within the vehicle 100. For example, the monitoring application 50 may include a seatbelt monitor 52 configured to detect whether a seatbelt 120 of the seat 102 is engaged when an object 200 is present. The seatbelt monitor 52 may be triggered based on the object class 36 to monitor a seatbelt status 122 of the seatbelt 120. For example, the seat sensor application 18 may generate, based on the object class, a signal 44 corresponding to the object 200 based on the object class 36. The signal 44 is communicated with the monitoring application 50, and the monitoring application 50 may issue a notification 54 at a user interface 124 of the vehicle 100.

If the object 200 is classified as one of the animate classes 36a, then the monitoring application 50 may trigger the seatbelt monitor 52 to determine a status of the seatbelt 120. In some instances, the seatbelt monitor 52 may be configured to exclude the pet class 36a₃. However, a user of the seat sensor system 10 may customize the monitoring application 50 to reflect user preferences for activation of the seatbelt 120 with the pet class 36a₃. If the object 200 is classified in the animate class 36a and the seatbelt 120 is detected as being disengaged, the monitoring application 50 may issue the notification 54 to alert the occupant to engage the seatbelt 120.

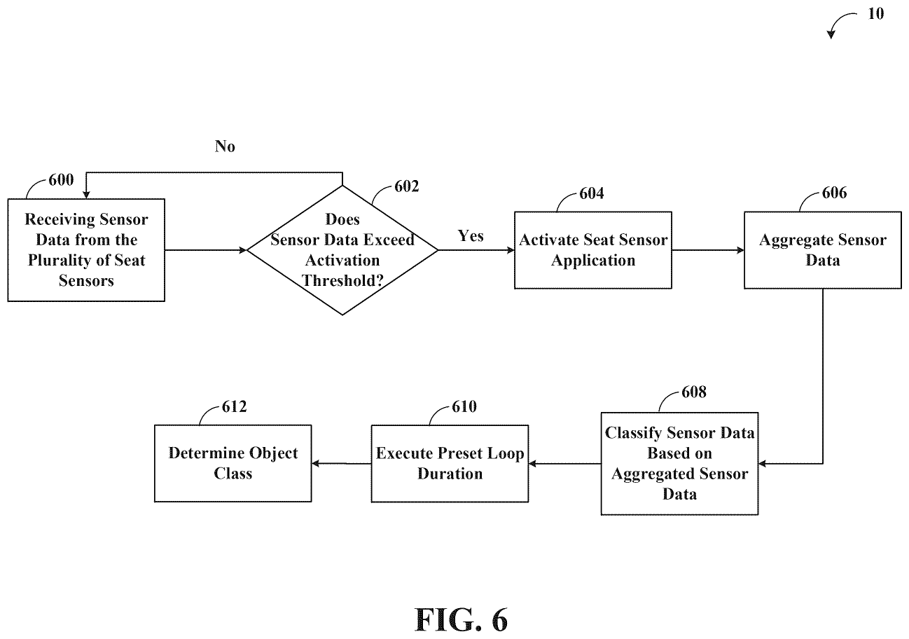

Referring to FIG. 6, an example flow diagram for the seat sensor system 10 is illustrated with the controller 14 receiving, at 600, the sensor data 20 from the plurality of seat sensors 12. At 602, the data processing hardware 16 determines whether the sensor data 20 exceeds the activation threshold 24. If not, the data processing hardware 16 continues to monitor, at 600, the sensor data 20 received at the controller 14. If the sensor data 20 exceeds the activation threshold 24, the data processing hardware 16 activates, at 604, the seat sensor application 18. In response, the seat sensor application 18 aggregates, at 606, the sensor data 20 and classifies, at 608, the object 200 based on the aggregated sensor data 20. The seat sensor application 18 executes, at 610, a preset loop duration 42 of the aggregation function 30 and the classification function 34 until the seat sensor application 18 determines, at 612, the object class 36.

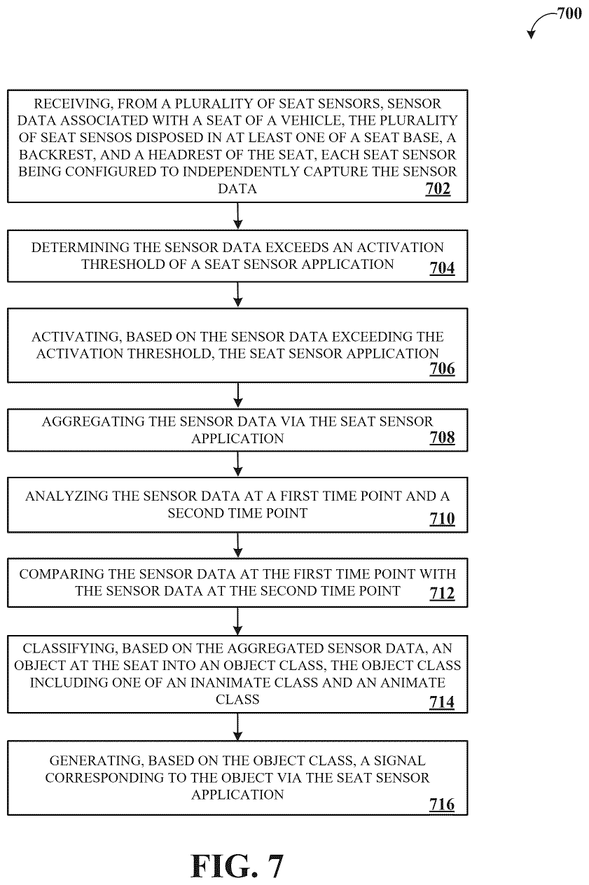

Referring to FIG. 7, an exemplary method 700 of operation for the seat sensor system 10 is illustrated. At 702, the controller 14 receives, from a plurality of seat sensors 12, sensor data 20 associated with a seat 102 of a vehicle 100. The plurality of seat sensors 12 are disposed in at least one of a seat base 104, a backrest 106, and a headrest 108 of the seat 102, and each seat sensor 12 is configured to independently capture the sensor data 20. The data processing hardware 16 determines, at 704, the sensor data 20 exceeds an activation threshold 24 of a seat sensor application 18. The data processing hardware 16 activates, at 706, the seat sensor application 18 based on the sensor data 20 exceeding the activation threshold 24. At 708, the seat sensor application 18 aggregates the sensor data 20 and analyzes, at 710, the sensor data 20 at a first time point 38a and a second time point 38b.

The seat sensor application 18 compares, at 712, the sensor data 20 at the first time point 38a with the sensor data 20 at the second time point 38b and classifies, at 714, based on the aggregated sensor data 20, an object 200 at the seat 102 into an object class 36. The object class 36 includes one of an inanimate class 36b and an animate class 36a. At 716, the controller 14 generates, based on the object class 36, a signal 44 corresponding to the object 200 via the seat sensor application 18.

Referring again to FIGS. 1-7, the seat sensor system 10 advantageously assists in identifying and classifying objects 200 positioned on the seats 102 of a vehicle 100. The classification function 34 may differentiate between inanimate and animate objects 200, such that the object class 36 may be utilized to determine whether to issue a notification 54. The notification 54 may pertain to a seatbelt status 122 and may be projected via the user interface 124 of the vehicle 100. The notification 54 may also pertain to other operative states related to the seats 102 including, but not limited to, a position of the object 200 on the seat 102. Thus, the seat sensor system 10 may also be utilized to monitor safe positioning of the object 200 on the seat 102.

The independent detection of sensor data 20 by each individual seat sensor 12 advantageously provides the seat sensor application 18 with precise information regarding the object 200 on the seat 102. The seat sensor application 18 is able to utilize specific sensor data 20 from each seat sensor 12 to compare detection of the object 200 at precise locations on the seat 102. For example, adjacent seat sensors 12 may provide slight deviations in sensor data 20 that may inform classification of the object 200 and provide improved accuracy of the classification function 34. Further, the repeated loop of executing the aggregation function 30 and the classification function 34 assists in improving the classification of the object 200 based on the repeated analysis of sensor data 20 received at the seat sensor application 18.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method when executed by data processing hardware causes the data processing hardware to perform operations comprising:
receiving, from a plurality of seat sensors, sensor data associated with a seat of a vehicle;
determining the sensor data exceeds an activation threshold of a seat sensor application;
activating, based on the sensor data exceeding the activation threshold, the seat sensor application;
aggregating the sensor data via the seat sensor application;
classifying, based on the aggregated sensor data, an object at the seat into an object class; and
generating, based on the object class, a signal corresponding to the object via the seat sensor application.

2. The method of claim 1, wherein the sensor data includes pressure data, spatial data, and temporal data.

3. The method of claim 2, wherein classifying the object includes analyzing the sensor data at a first time point and a second time point and comparing the sensor data at the first time point with the sensor data at the second time point.

4. The method of claim 3, wherein comparing the sensor data at the first time point with the sensor data at the second time point includes identifying a location change of the object.

5. The method of claim 4, wherein identifying the location change includes detecting, via a first seat sensor, the sensor data at the first time point and detecting, via a second seat sensor, the sensor data at the second time point.

6. The method of claim 1, wherein the plurality of seat sensors are linear piezoelectric sensors, each seat sensor being configured to independently capture the sensor data.

7. The method of claim 1, wherein seat sensors of the plurality of seat sensors are disposed in one or more of a seat base, a backrest, a headrest, and armrests of the seat and a floor space proximate to the seat.

8. The method of claim 1, wherein classifying the object includes identifying the object class based on the sensor data, the object class including one of a child class, an adult class, a pet class, and an inanimate class.

9. The method of claim 1, wherein generating the signal includes issuing a notification at a user interface of the vehicle.

10. A seat sensor system comprising:
data processing hardware; and
memory hardware in communication with the data processing hardware, the memory hardware storing instructions that when executed on the data processing hardware cause the data processing hardware to perform operations comprising:
receiving, from a plurality of seat sensors, sensor data associated with a seat of a vehicle, the plurality of seat sensors disposed in at least one of a seat base, a backrest, and a headrest of the seat;
determining the sensor data exceeds an activation threshold of a seat sensor application;
activating, based on the sensor data exceeding the activation threshold, the seat sensor application;
aggregating the sensor data via the seat sensor application;
classifying, based on the aggregated sensor data, an object at the seat into an object class, the object class including one of an inanimate class and an animate class; and
generating, based on the object class, a signal corresponding to the object via the seat sensor application.

11. The seat sensor system of claim 10, wherein the sensor data includes pressure data, spatial data, and temporal data.

12. The seat sensor system of claim 11, wherein classifying the object includes analyzing the sensor data at a first time point and a second time point and comparing the sensor data at the first time point with the sensor data at the second time point.

13. The seat sensor system of claim 12, wherein comparing the sensor data at the first time point with the sensor data at the second time point includes identifying a location change of the object.

14. The seat sensor system of claim 13, wherein identifying the location change includes detecting, via a first seat sensor, the sensor data at the first time point and detecting, via a second seat sensor, the sensor data at the second time point.

15. The seat sensor system of claim 10, wherein the plurality of seat sensors are linear piezoelectric sensors, each seat sensor being configured to independently capture the sensor data.

16. The seat sensor system of claim 10, wherein generating the signal includes issuing a notification at a user interface of the vehicle.

17. A seat sensor system for a vehicle, the seat sensor system comprising:
data processing hardware; and
memory hardware in communication with the data processing hardware, the memory hardware storing instructions that when executed on the data processing hardware cause the data processing hardware to perform operations comprising:
receiving, from a plurality of seat sensors, sensor data associated with a seat of the vehicle, the plurality of seat sensors disposed in at least one of a seat base, a backrest, and a headrest of the seat, each seat sensor being configured to independently capture the sensor data;
determining the sensor data exceeds an activation threshold of a seat sensor application;
activating, based on the sensor data exceeding the activation threshold, the seat sensor application;
aggregating the sensor data via the seat sensor application;
analyzing the sensor data at a first time point and a second time point;
comparing the sensor data at the first time point with the sensor data at the second time point;
classifying, based on the aggregated sensor data, an object at the seat into an object class, the object class including one of an inanimate class and an animate class; and
generating, based on the object class, a signal corresponding to the object via the seat sensor application.

18. The seat sensor system of claim 17, wherein the sensor data includes pressure data, spatial data, and temporal data.

19. The seat sensor system of claim 18, wherein comparing the sensor data at the first time point with the sensor data at the second time point includes identifying a location change of the object.

20. The seat sensor system of claim 19, wherein identifying the location change includes detecting, via a first seat sensor, the sensor data at the first time point and detecting, via a second seat sensor, the sensor data at the second time point.
